(19) United States
(12) Patent Application Publication
(10) Pub. No.: US 2002/0027062 A1
(43) Pub. Date: Mar. 7, 2002

(54) Push-button switch and multiple switch using the same

(76) Inventors: Shigeru Shibutani, Fukui (JP); Tetsuo Murakami, Osaka (JP); Yoshihiko Kamimura, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 09/931,871

(22) Filed: Aug. 20, 2001

(30) Foreign Application Priority Data
Aug. 21, 2000 (JP) 2000-249347

(51) Int. Cl. H01H 13/70

(52) U.S. Cl. 200/5 R

(57) ABSTRACT

A push-button switch includes an insulating board, an actuator, an urging body and a push button. The insulating board has plural switch-contacts. The actuator is made of resilient material and includes a base section placed on the board, a first and second actuating sections. Both the sections are disposed above the switch-contacts and linked to the base section via respective linking sections. The urging body has a first end rotatably supported by a supporting section formed on the actuator or another supporting section formed on the insulating board, and a second end for urging the first actuating section. The push button depresses a mid-section of the urging body. The structure discussed above allows the push-button switch to have various combinations of operating forces and strokes. The push-button switch and a multiple switch employing this push-button switch can be used in various electronic apparatuses.

### FIELD OF THE INVENTION

The present invention relates to a push-button switch employed in various electronic apparatuses, such as television receivers and video cassette recorders, and it also relates to a multiple switch using the push-button switch.

### BACKGROUND OF THE INVENTION

Recently the market has demanded that electronic apparatuses have versatile and advanced functions. This market situation entails versatile applications and specifications for push-button switches. To be more specific, in addition to switching a mono-function with one push-button, move a cursor on a screen for instance, up and down, side to side with a plurality of push-buttons, and select a menu with another push-button, have increased in the market.

Such a conventional push-button switch is described with reference to FIG. 13 to FIG. 15. FIG. 13 is a cross sectional view of the conventional push-button switch, and FIG. 14 is an exploded perspective view of the same switch. In FIGS. 13 and 14, insulating board 1 has a plurality of conductive patterns (not shown) on its upper and lower faces. A pair of fixed contacts 1A is disposed at the center of the upper surface of board 1, and four sets of fixed contacts 1B are radially formed with equally spaced apart around contacts 1A.

Actuator 2 is made of resilient material such as rubber. Base section 2A of actuator 2 forms approx. a flat board and overlies board 1. On base section 2A, first actuating section 2B and second actuating section SC protrude upward, and linking sections 2D and 2E for linking both actuating sections 2B and 2C to base section 2A are formed. Each of linking sections 2D and 2E forms a thin dome.

Movable contacts 2F and 2G are formed on the underside of actuating sections 2B and 2C, and face respective fixed contacts 1A and 1B at a given space. Case 3, of which underside is open, covers actuator 2. Case 3 is made of insulating resin, and has five openings 3A on its upper surface. Through openings 3A, actuating sections 2B and 2C protrude upwardly.

Operation of the conventional push-button switch discussed above is described. The upper surfaces of actuating sections 2B and 2C protruded from the upper surface of case 3 are depressed, then actuating sections 2B and 2C move downward bending linking sections 2D and 2E. Movable contacts 2F and 2G are brought into contact with fixed contacts 1A and 1B on board 1, thereby closing the pair of contact points 1A and 1B.

When the pressure to the actuating sections is removed, movable contacts 2F and 2G spring back to neutral position (contacts are open) shown in FIG. 13 due to elastic restoring force of linking sections 2D and 2E.

This type of push-button switch is mounted to an operation panel of an electronic apparatus and connected to an electronic circuit of the apparatus. This switch is used, for instance, in the following application: any one of four second actuating sections 2C is depressed to move the cursor up and down, side to side in the screen, then first actuating section 2B is depressed to select an item from a menu.

In this conventional switch, the shapes or the thickness of actuating sections 2B and 2C or linking sections 2D and 2E can be varied, thereby changing operating force or a stroke of the switch somewhat. However, it is difficult to set significantly different operating force and a stroke for respective actuating sections 2B and 2C due to the limitations such as a size and a layout of the entire switch, although the respective actuating sections are to be used for different functions.

### SUMMARY OF THE INVENTION

The present invention addresses the problem discussed above, and aims to offer a push-button switch of which operating force and a stroke can be variously set in accordance with an application. The push-button switch of the present invention comprises the following elements:

(a) an insulating board on which a plurality of switch-contacts are formed;

(b) an actuator made of resilient material and including;

a base section on the insulating board;

a first actuating section coupled to the base section via its linking section;

a second actuating section being coupled to the base section via its linking section;

(c) an urging body including:

a first end journaled by a supporting section formed on the insulating board or another supporting section formed on the actuator; and

a second end for urging the first actuating section; and

(d) an operating button for depressing the mid section of the urging body.

This structure allows the push-button switch to be operated in the following way: Depressing force travels to the first actuating section via the urging body and also travels to the second actuating section directly, not via the urging body. The first and second actuating sections thus have substantially different operating forces and strokes, so that various combinations of operating forces and strokes can be prepared for the push-button switch. A multi-switch employing this push-button switch can be provided.

### BRIEF DESCRIPTION OF THE DRAWINGS

FIG. 1 is a cross section of a push-button switch in accordance with a first exemplary embodiment of the present invention.

FIG. 2 shows an exploded perspective view of the push-button switch shown in FIG. 1.

FIG. 3 is a cross section of the push-button switch in accordance with the first exemplary embodiment taken along a line different from FIG. 1.

FIG. 4 and FIG. 5 are cross sections of the push-button switch at operation in accordance with the first exemplary embodiment of the present invention.

FIG. 6 is a cross section of a push-button switch in accordance with a second exemplary embodiment of the present invention.

FIG. 7 is a cross section of a push-button switch in accordance with a third exemplary embodiment of the present invention.

FIG. 8 is a cross section of a push-button switch in accordance with a fourth exemplary embodiment of the present invention.

FIG. 9 is a cross section of a push-button switch in accordance with a fifth exemplary embodiment of the present invention.

FIG. 10 is a cross section of the push-button switch in accordance with the fifth exemplary embodiment taken along a line different from FIG. 9.

FIG. 11 is a cross section of a push-button switch in accordance with a sixth exemplary embodiment of the present invention.

FIG. 12 is an exploded perspective view of a multi-switch in accordance with a seventh exemplary embodiment of the present invention.

FIG. 13 is a cross section of a conventional push-button switch.

FIG. 14 is an exploded perspective view of the push-button switch shown in FIG. 13.

FIG. 15 is a cross section of the conventional push-button switch at operation.

### DETAILED DESCRIPTION OF THE IVNENTION

Exemplary embodiments of the present invention are demonstrated hereinafter with reference to the accompanying drawings. Elements similar to those in the conventional case have the same reference numbers, thus the descriptions of those elements are omitted.

### Exemplary Embodiment 1

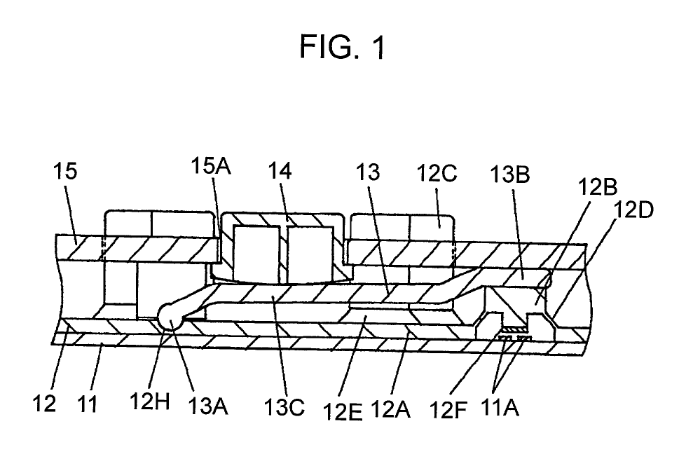

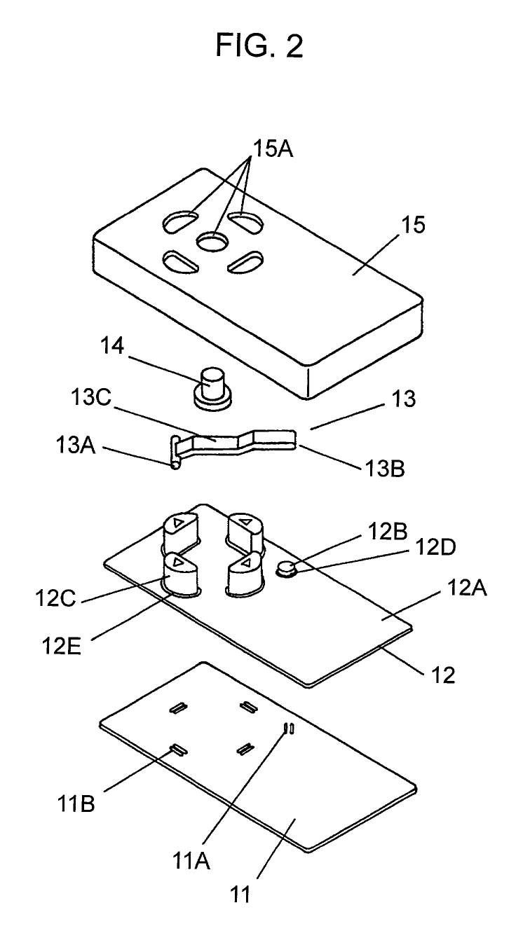

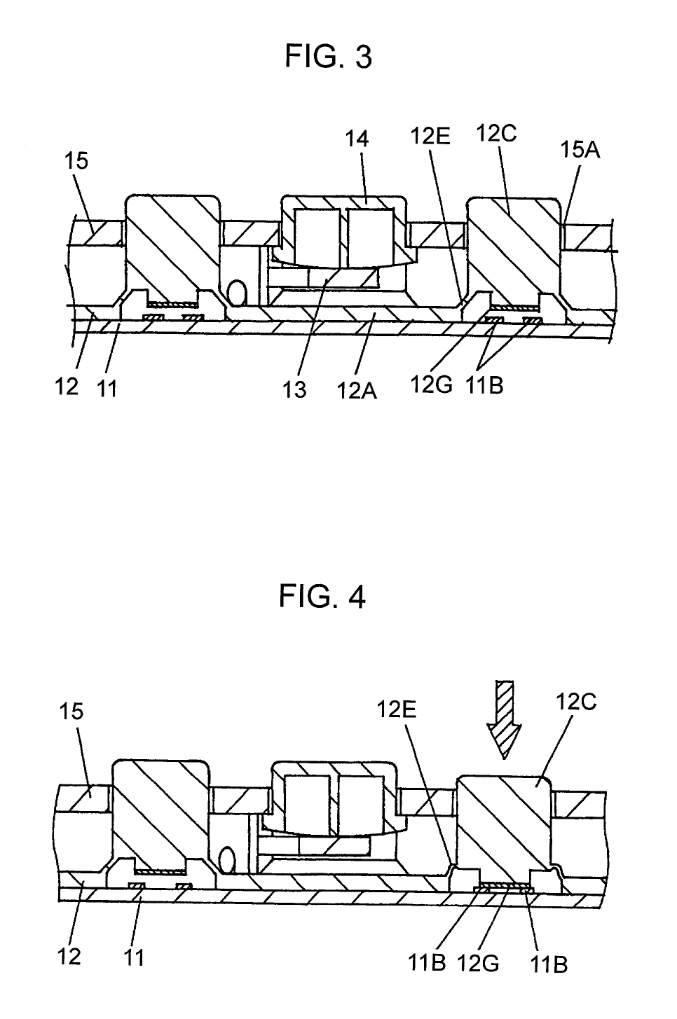

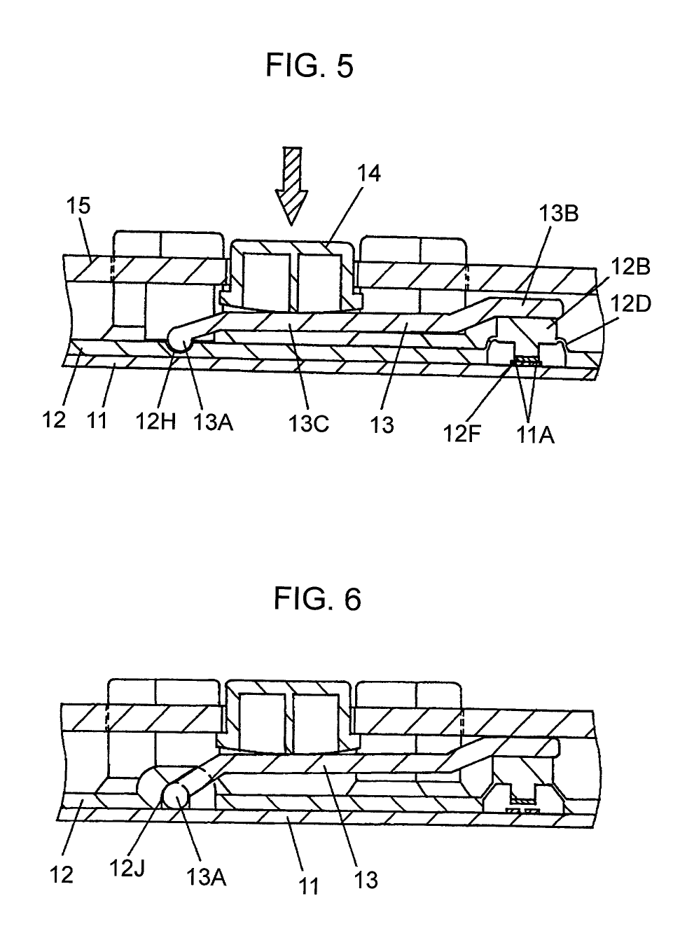

FIG. 1 is a cross section of a push-button switch in accordance with a first exemplary embodiment of the present invention. FIG. 2 shows an exploded perspective view of the push-button switch shown in FIG. 1. FIG. 3 is a cross section of the push-button switch in accordance with the first exemplary embodiment taken along a line different from FIG. 1. FIG. 4 and FIG. 5 are cross sections of the push-button switch at operation.

In those drawings, insulating board 11 has a plurality of conductive patterns (not shown) on both upside and underside thereof. The conductive patterns are made of carbon ink or metallic foil. Further on insulating board 11, a pair of fixed contacts 11A is provided, and four pairs of fixed contacts 11B are also provided radially and equally spaced apart.

Actuator 12 is made of resilient material such as rubber or elastomer. Base section 12A overlies actuator 12 and forms approx. flat board. On base section 12A, first actuating section 12B protrudes upward, and four actuating sections 12C protrude upward. Linking section 12D links first actuating section 12B to base section 12A, and another linking sections 12E link second actuating sections 12C respectively to base section 12A. Linking sections 12D, 12E are made of thin member and form approx. domes respectively.

On the undersides of actuating sections 12B and 12C, movable contacts 12F and 12G are formed of, e.g., carbon ink with a given space from corresponding fixed contacts 11A and 11B.

Urging body 13 and push-button 14 are made of insulating resin. Shaft 13A is provided at a first end of urging body 13. Shaft 13A is journaled by U-shaped supporting section 12H. Urging section 13B is provided at a second end of urging body 13. Urging section 13B is brought into contact with upper surface of actuating section 12B. Underside of push-button 14 is brought into contact with the upper surface of mid section 13C of urging body 13.

Case 15, made of insulating resin, covers a part of or all of the elements discussed above. Case 15 has an opening on its underside, and five holes 15A on its upper side. Through these holes 15A, push-button 14 and actuating sections 12C are protrude upward. When those elements discussed above are assembled, actuating sections 12C are equally spaced apart around push-button 14.

Operation of the push-button switch structured above is demonstrated hereinafter. The push-button switch is at neutral position shown in FIG. 3. The upper surface of actuating section 12C is depressed, then actuating section 12C moves downward bending linking section 12E, which entails movable contact 12G at underside of actuating section 12C to be brought into contact with fixed contact 11B on the upper surface of board 11. As a result, contact 11B is closed.

When the depressing force is removed from actuating section 12C, movable contact 12G leaves fixed contact 11B (contact 11B is opened) and actuating section 12C springs back to the neutral position shown in FIG. 3.

On the other hand, when push-button 14 is at the neutral position shown in FIG. 1, the upper face of push-button 14 is depressed. Then the underside of push-button 14 depresses the upper side of mid section 13C of urging body 13, which entails urging body 13 to rotate downward on shaft 13A held by supporting section 12H, and urging section 13B urges the upper face of actuating section 12B. As a result, actuating section 12B moves downward bending linking-section 12D, and movable contact 12F provided at underside of actuating section 12B is brought into contact with fixed contact 11A on board 11. Contact 11A is thus closed (electrically connected.)

When the depressing force is removed from push-button 14, actuating section 12B springs back upward due to resilient restoring force, and actuating section 12B pushes urging body 13 as well as push-button 14 back to the neutral position shown in FIG. 1.

At this time, push-button 14 depresses mid-section 13C of urging body 13 which rotates on shaft 13A provided at the first end of urging body 13, and urging section 13B at the second end urges the upper surface of actuating section 12B. In this case, greater operating force is produced by push-button 14 and smaller stroke is produced than the case when actuating section 12B is directly depressed.

For instance, when mid section 13C is positioned at approx. the center of urging body 13, as much as approx. two times of operating force is produced by push-button 14 and a half of the stroke is effected comparing with the case when actuating section 12B is directly depressed. The distance between mid-section 13C and shaft 13A decreases at greater operating force and smaller stroke.

The push-button switch structured above is mounted to an operation panel of an electronic apparatus, and connected to the electronic circuit of the apparatus. For instance, any one of four actuating sections 12C is depressed, thereby moving the cursor on the screen. Then push-button 14 is depressed, thereby selecting an item from a menu. This usage is the same as the prior art.

According to the first embodiment, actuating section 12B is urged indirectly through urging body 13 by depressing push button 14, while actuating section 12C is directly urged. Therefore, actuating sections 12B and 12C can have largely different operating forces and strokes. As a result, operating forces and strokes of various combinations can be produced by this push-button switch.

A plurality of fixed contacts 11A and 11B are disposed on board 11, and movable contacts 12F and 12G are disposed on the underside of actuating sections 12B and 12C with a given space from contacts 11A and 11B, so that contacts 12F and 12G face contacts 11A and 11B. This structure allows the switch-contacts to be simply built with less components at a lower cost.

Instead of movable contacts 12F and 12G, resilient insulating film is bonded to the upper surface of a board with a given space from the board (like an arch bridge), and a plurality of movable contacts facing the fixed contacts 12F and 12G are formed on the underside of the film. The upper side of these movable contacts is depressed by actuating sections 12B and 12C. The switch-contacts of membrane type can be thus employed.

### Exemplary Embodiment 2

FIG. 6 is a cross section of a push-button switch in accordance with the second exemplary embodiment of the present invention. The second embodiment differs from the first one in the following point. In the first embodiment, shaft 13A—the end of urging body 13—is journaled between supporting section 12H of actuator 12 and a protrusion on the underside of case 15; however, in the second embodiment, shaft 13A is journaled between supporting section 12J formed on the underside of actuator 12 and the upper surface of insulating board 11 as shown in FIG. 6. The second embodiment can achieve the same advantages as the first one.

### Exemplary Embodiment 3

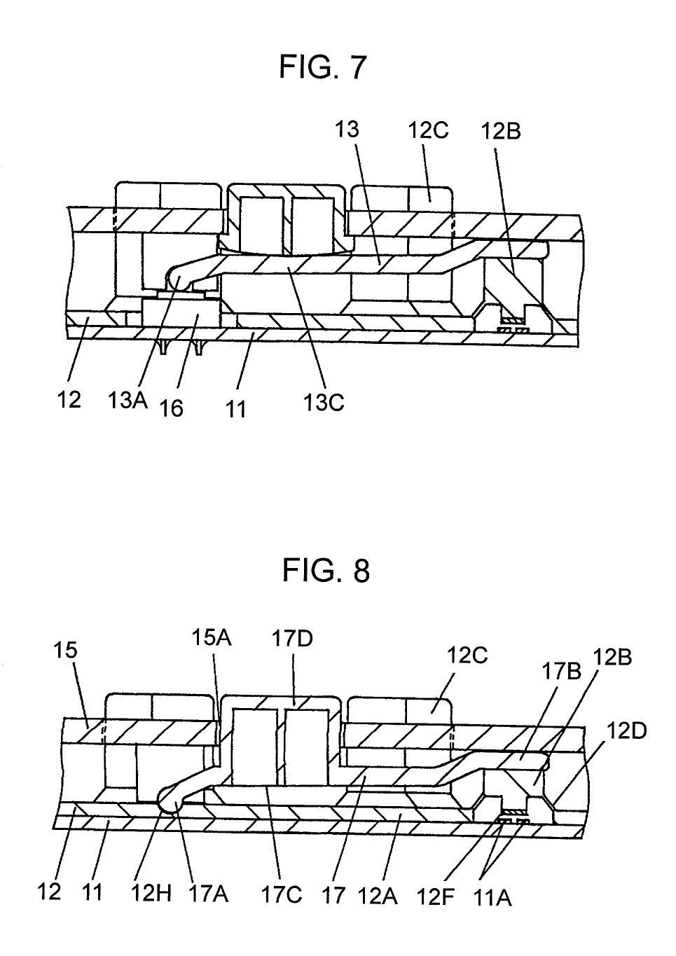

FIG. 7 is a cross section of a push-button switch in accordance with the third exemplary embodiment of the present invention. The third embodiment differs from the first one in the following point: Push switch 16 is disposed on the upper face of board 11 as shown in FIG. 7. Push switch 16 is urged by shaft 13A of urging body 13 and switched at a different timing from that of the contacts switched by first actuating section 12B or second actuating section 12C. Therefore, more versatile switchings can be expected in this push-button switch than in the first embodiment. Switch 16 can be urged by mid section 13C instead of shaft 13A.

### Exemplary Embodiment 4

FIG. 8 is a cross section of a push-button switch in accordance with the fourth exemplary embodiment of the present invention. The fourth embodiment differs from the first one in the following point: In the first embodiment, urging body 13 and push button 14 are independently formed as shown in FIG. 1; however, in the fourth embodiment, a protrusion from mid-section 17C of urging body 17 functions as the push button, and thus the push button is unitarily formed with urging body 17 as operating section 17D.

Operation of the fourth embodiment is demonstrated here. Operating section 17D, protruded from the upper surface of case 15, is depressed, then urging body 17 unitarily formed with operating section 17D rotates downward on shaft 17A disposed at the first end, and urging section 17B at the second end urges the first actuating section 12B upward.

Then actuating section 12B moves downward bending linking-section 12D, and movable contact 12F provided on the underside of actuating section 12B is brought into contact with fixed contact 11A on board 11. Thus fixed contact 11A is electrically connected via movable contact 12F. When the depressing force is removed from operating section 17D, actuating section 12B springs back upward due to the resilient restoring force of linking-section 12D, and actuating section 12B pushes urging body 17 back to the original position.

As such, according to the fourth embodiment, a push button, i.e. operating section 17D, is unitarily formed with urging body 17 at mid section 17C, thereby obtaining an inexpensive push-button switch with less components and easy construction.

### Exemplary Embodiment 5

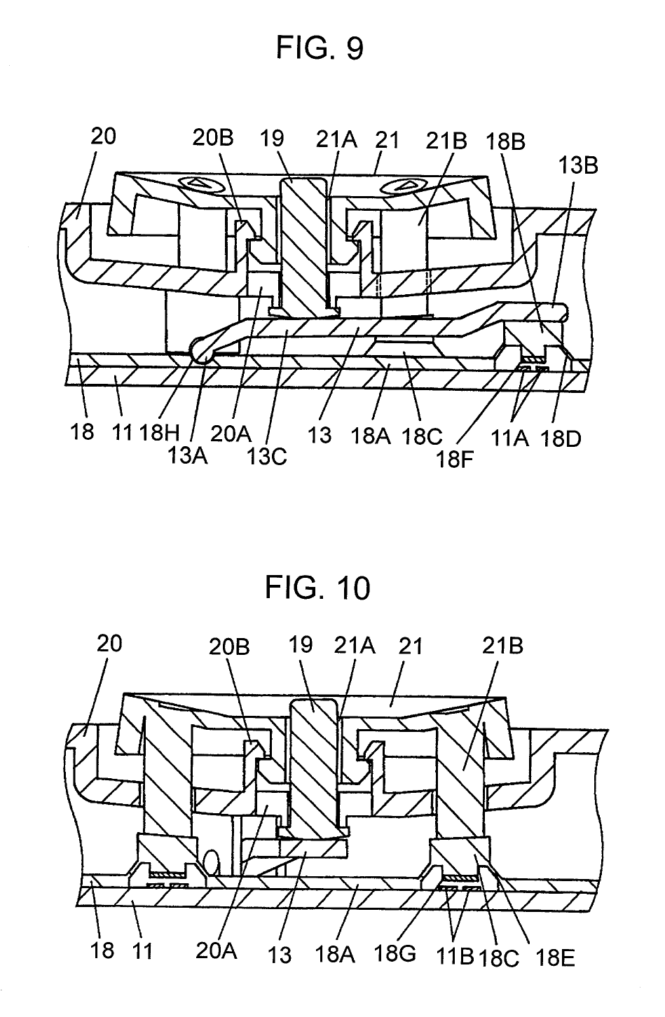

FIG. 9 is a cross section of a push-button switch in accordance with the fifth exemplary embodiment of the present invention. FIG. 10 is a cross section of the push-button switch taken along a line different from FIG. 9.

The fifth embodiment differs from the first one in the following point. In FIG. 10, push-button 19 protrudes upward through opening 20A of case 20 as same as the first embodiment. In this fifth embodiment, engaging claw 20B is provided to case 20, and the center of hat button 21 made of insulating resin is engaged in a rocking manner with claw 20B.

The tip of push-button 19 protrudes out of through hole 21A drilled at the center of hat button 21. Four protrusions 21B provided on the underside rim of hat button 21 are brought into contact with the upper side of four second actuating sections 18C, so that a push-switch is constructed.

Operation of the fifth embodiment is demonstrated hereafter. At the neutral position shown in FIG. 9, push-button 19 is depressed, then urging body 13 rotates downward on shaft 13A, and urging section 13B urges the upper face of first actuating section 18B, so that fixed contact 11A is coupled electrically to movable contact 18F. Hitherto is the same as the first embodiment. In this fifth embodiment, actuating section 18C is depressed by rocking hat-button 21.

In other words, at the neutral position shown in FIG. 10, when the right side of upper surface of hat button 21 is depressed for instance, hat button 21 rocks on the center of the underside engaged with claw 20B of case 20 as a fulcrum. Then protrusion 21B disposed at the underside rim of hat button 21 depresses the upper surface of actuating section 18C. This depression entails actuating section 18C to move downward bending linking-section 18E, and fixed contact 11B is coupled electrically to movable contact 18G.

The push-button switch structured above is mounted to an operation panel of an electronic apparatus, and connected to the electronic circuit of the apparatus. For instance, hat button 21 is rocked, thereby moving the cursor on the screen. After that, push-button 19 at the center is depressed to select an item from a menu. This usage is the same as the first embodiment.

According to the fifth embodiment, hat button 21 is provided and has through-hole 21A at its center through which push-button 19 protrudes. Rocking this hat button 21 depresses actuating section 18C disposed at the outer rim of hat button 21. Thus a spot somewhat deviated on the upper surface of hat button 21 is depressed, and actuating section 18C thereunder can be depressed without fail. As a result, a push-button switch easy to operate is obtainable.

### Exemplary Embodiment 6

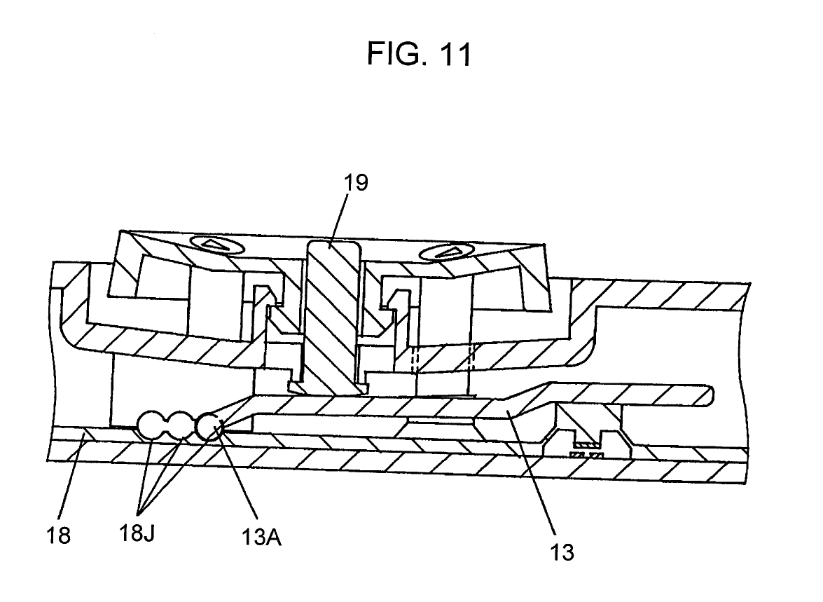

FIG. 11 is a cross section of a push-button switch in accordance with the sixth exemplary embodiment of the present invention. The sixth embodiment differs from the first one in the following point: As shown in FIG. 11, a plurality of approx. U-shaped supporting sections 18J are provided to actuator 18 so that shaft 13A of urging body 13 can be supported by a plurality of the supporting sections. This structure allows push-button 19 to change easily its operating force as well as stroke without changing the parts but by just changing the position of supporting section 18J where shaft 13A is inserted.

### Exemplary Embodiment 7

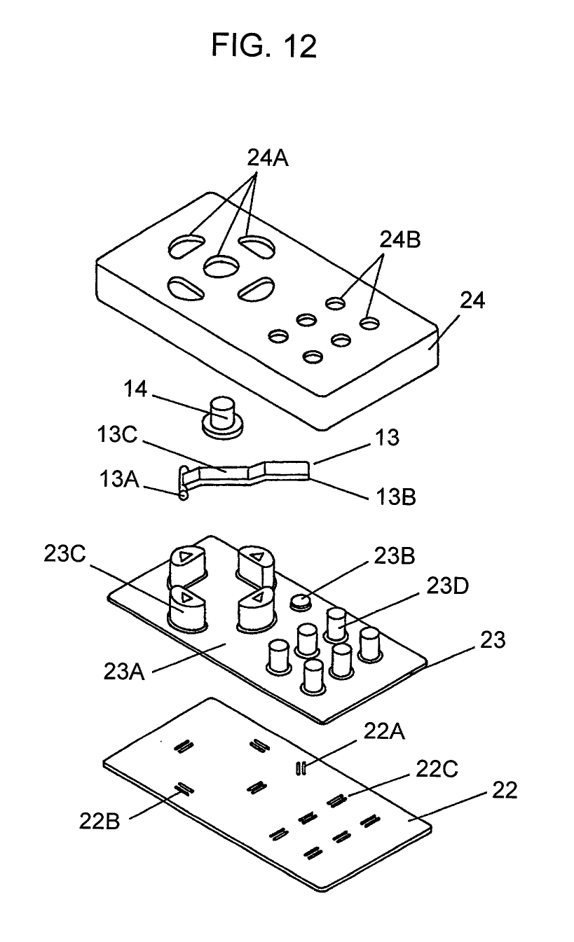

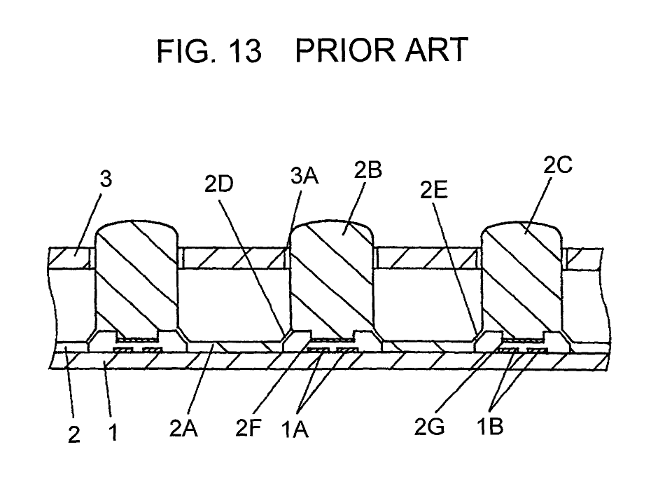

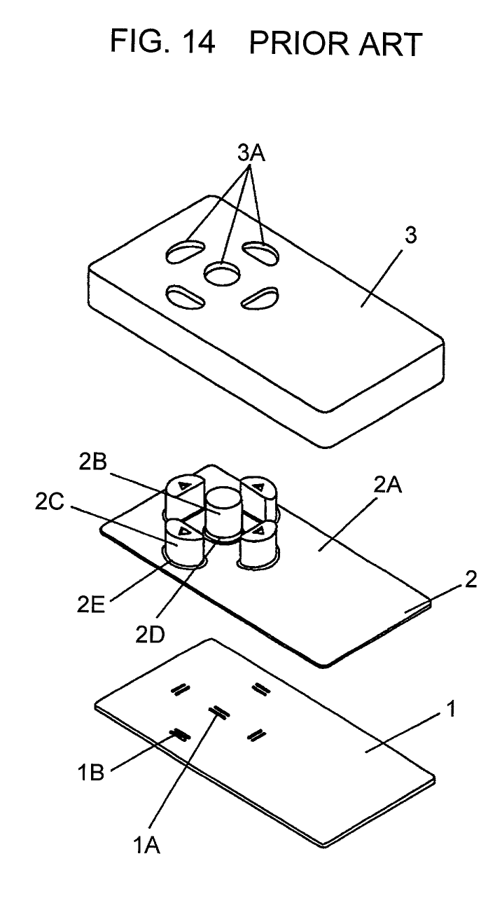

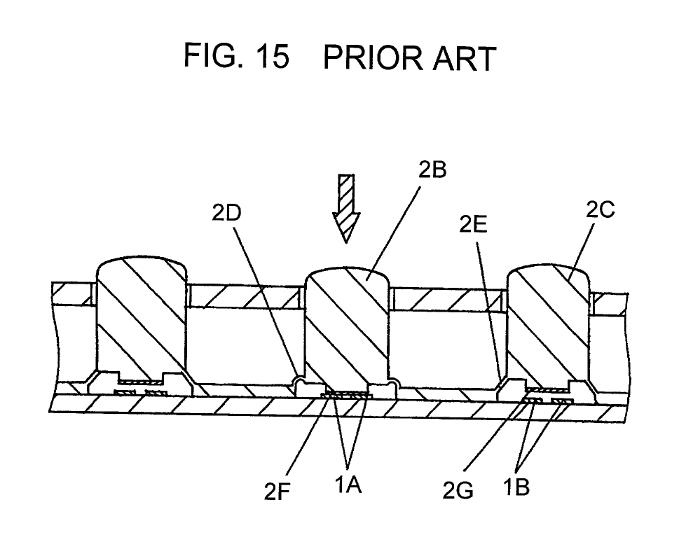

FIG. 12 is an exploded perspective view of a multi-switch in accordance with the seventh exemplary embodiment of the present invention. In FIG. 12, the following structural points are the same as the first embodiment: (1) A pair of fixed contacts 22A and four pairs of fixed contacts 22B are disposed on the upper surface of insulating board 22. (2) First actuating section 23B and four second actuating sections 23C are formed on the upper surface of base section 23A of actuator 23. (3) Shaft 13A at a first end of urging body 13 is journaled by actuator 23. (4) Urging section 13B at a second end of urging body 13 is brought into contact with the upper surface of actuator 23B, and the underside of push-button 14 is brought into contact with the upper surface of mid-section 13C.

This seventh embodiment differs from the first one in the following point: On the upper surface of base section 23A of actuator 23, a plurality of third actuating sections 23D are formed in addition to and similar to actuating sections 23B and 23C. Movable contacts (not shown) are formed on the respective undersides of actuating sections 23D, and fixed contacts 22C are formed on the upper face of insulating board 22 correspondingly to and with a given space from the movable contacts. Case 24 covers those elements, and push-button 14 as well as actuating sections 23C protrudes upward from opening 24A. A plurality of actuating sections 23D protrude upward from opening 24B. A multiple switch is thus constructed.

The push-button switch structured above is mounted to an operation panel of an electronic apparatus, and connected to the electronic circuit of the apparatus. For instance, actuating section 23C is depressed, thereby moving the cursor on the screen. Then push-button 14 is depressed, thereby selecting an item from a menu. Hitherto is the same as the first embodiment; however, in the seventh embodiment, depressing actuating sections 23D can switch other functions than discussed above in the apparatus.

According to the seventh embodiment, a plurality of actuating sections 23D are provided in addition to the push-button switch shown in the first embodiment, so that a plurality of switches are formed. As a result, a multiple switch having versatile functions with less components is obtainable at an inexpensive cost and by simple assembly.

In the descriptions above, the push-button switch or the multiple switch is mounted to an operation panel of an electronic apparatus and coupled to an electronic circuit. However, electronic parts are mounted on an insulating board to form a transmitting circuit, thereby constructing a remote controlling transmitter independent of the electronic apparatus.

According to the present invention, a push-button switch using various combinations of operating forces and strokes is obtainable, and a multiple switch using the push-button switch is also obtainable.

What is claimed is:

1. A push-button switch comprising:
(a) an insulating board having a plurality of switch-contacts;
(b) an actuator made of resilient material, said actuator including;
(b-1) a base section disposed on said insulating board;
(b-2) a first actuating section and a second actuating section both disposed over the switch contacts and coupled to said base section via respective linking sections of the first and the second actuating sections;
(c) an urging body including;
(c-1) a first end rotatably supported by one of a supporting section formed on said actuator and another supporting section formed on said insulating board;
(c-2) a second end for urging said first actuating section; and
(d) a push button for depressing a mid section of said urging body.

2. The push-button switch of claim 1, wherein said first end has a shaft, and said second end has an urging section.

3. The push-button switch of claim 1, wherein the linking sections are made of thin member and shape in approx. domes.

4. The push-button switch of claim 1, wherein said second actuating section is disposed on an outer circumference of said push button.

5. The push-button switch of claim 1, wherein the switch-contacts are fixed contacts provided on an upper surface of said insulating board, and said push-button switch further comprises a plurality of moving contacts disposed on undersides of said first actuating section and said second actuating section with a given space from the fixed contacts, said moving contacts facing the fixed contacts.

6. The push-button switch of claim 1, wherein the push button is unitarily formed with said urging body at the mid section of said urging body.

7. The push-button switch of claim 4 further comprising a hat button having a through hole for the push button to extends through, wherein said hat button is operated for depressing said second actuating section.

8. The push-button switch of claim 2, wherein a plurality of the supporting sections are formed, and the shaft is supported by one of the supporting sections.

9. The push-button switch of claim 2, the switch-contacts are disposed on an upper surface of said insulating board and are depressed by one of the shaft and the mid section.

10. A multiple switch comprising:
a push-button switch including:
(a) an insulating board having a first plurality of switch-contacts;
(b) an actuator made of resilient material, said actuator including;
(b-1) a base section disposed on said insulating board;
(b-2) a first actuating section and a second actuating section both disposed over the first switch contacts and coupled to said base section via respective linking sections of the first and the second actuating sections;
(c) an urging body including;
(c-1) a first end rotatably supported by one of a supporting section formed on said actuator and another supporting section formed on said insulating board;
(c-2) a second end for urging said first actuating section;
(d) a push button for depressing a mid section of said urging body,
a third actuating section formed on the base section of said actuator of said push-button switch; and
a second switch contacts disposed on an upper surface of said insulating board under said third actuating section.
